(19) United States
(12) Patent Application Publication
(10) Pub. No.: US 2026/0175255 A1
(43) Pub. Date: Jun. 25, 2026

(54) Method for treating a workpiece and apparatus for treating workpieces

(71) Applicant: Ecoclean GmbH, Filderstadt (DE)

(72) Inventors: Hermann-Josef DAVID, Monschau (DE); Julia LAMPARTER, Stuttgart (DE)

(21) Appl. No.: 18/990,520

(22) Filed: Dec. 20, 2024

(51) Int. Cl. B05D 1/18; B05C 3/05; B05C 3/09; B05C 11/10; B05D 1/34

(52) U.S. Cl. CPC B05D 1/18; B05C 3/05; B05C 3/09; B05C 11/1002; B05D 1/34

(57) ABSTRACT

To provide a method for treating a workpiece, wherein the method comprises the following:
introducing at least one workpiece into a treatment chamber;
providing a bath of a liquid treatment agent in the treatment chamber;
cyclically changing the pressure in the treatment chamber while the treatment agent is in the treatment chamber;
   in which an enhanced treatment effect is achieved on the workpiece, it is proposed that the method further comprises the following:
carrying out at least one pressure change operation in the treatment chamber, during the course of which the pressure in the treatment chamber is decreased at least once and increased at least once while at least one treatment region of at least one workpiece is outside the bath of liquid treatment agent; and
carrying out at least one pressure change operation in the treatment chamber, during the course of which the pressure in the treatment chamber is decreased at least once and increased at least once while the at least one treatment region of the at least one workpiece is within the bath of liquid treatment agent.

### BACKGROUND OF THE INVENTION

The present invention relates to a method for treating a workpiece, wherein the method comprises the following:
introducing at least one workpiece into a treatment chamber;
providing a bath of a liquid treatment agent in the treatment chamber; and
cyclically changing the pressure in the treatment chamber while the treatment agent is in the treatment chamber.

Such a method is known from WO 2009/055834 A2. In this known method, a workpiece to be treated is completely immersed in the bath of liquid treatment agent and remains within the bath of liquid treatment agent throughout the entire treatment. The workpiece immersed in the liquid treatment agent can be heated cyclically using heating lamps, the intended purpose of which is to stimulate the formation of bubbles on the surface of the workpiece.

In particular, if the workpiece to be treated has narrow cavities, the method known from the prior art does not always achieve the desired treatment success.

### SUMMARY OF THE INVENTION

In accordance with an embodiment of the invention, a method for treating a workpiece of the type mentioned at the outset is provided, in which an enhanced treatment effect is achieved on the workpiece.

In accordance with an embodiment of the invention, a method for treating a workpiece is provided, wherein said method comprises the following:
introducing at least one workpiece into a treatment chamber;
providing a bath of a liquid treatment agent in the treatment chamber;
cyclically changing the pressure in the treatment chamber while the treatment agent is in the treatment chamber;
   wherein the method further comprises the following:
carrying out at least one pressure change operation in the treatment chamber, during the course of which the pressure in the treatment chamber is decreased at least once and increased at least once while at least one treatment region of at least one workpiece is outside the bath of liquid treatment agent; and
carrying out at least one pressure change operation in the treatment chamber, during the course of which the pressure in the treatment chamber is decreased at least once and increased at least once while the at least one treatment region of the at least one workpiece is within the bath of liquid treatment agent.

Since one and the same treatment region of a workpiece is subjected in each case to at least one pressure change operation both outside the bath of liquid treatment agent and within the bath of liquid treatment agent, the treatment effect of the pressure change operations is intensified.

In particular, it can be provided that narrow cavities of the workpiece are emptied of liquid treatment agent by the pressure change operation which is carried out while the treatment region of the workpiece is outside the bath of liquid treatment agent, and that these narrow cavities are completely filled with the liquid treatment agent by the pressure change operation which is carried out while the treatment region of the workpiece is within the bath of liquid treatment agent.

The interaction of the at least one pressure change operation in which the treatment region of the workpiece is outside the bath of liquid treatment agent and of the at least one pressure change operation in which the treatment region of the workpiece is within the bath of liquid treatment agent thus results in a particularly thorough exchange of media in cavities of the workpiece, thereby achieving an enhanced treatment effect.

In a particular embodiment of the invention, it is provided that the pressure change operation which is carried out while the at least one treatment region of the at least one workpiece is outside the bath of liquid treatment agent comprises a plurality of phases in which the pressure in the treatment chamber is decreased and/or a plurality of phases in which the pressure in the treatment chamber is increased.

Alternatively or additionally, it can be provided that the pressure change operation which is carried out while the at least one treatment region of the at least one workpiece is within the bath of liquid treatment agent comprises a plurality of phases in which the pressure in the treatment chamber is decreased and/or a plurality of phases in which the pressure in the treatment chamber is increased.

If several workpieces to be treated are in the treatment chamber at the same time, wherein a first workpiece is outside the bath of liquid treatment agent while a second workpiece is within the bath of liquid treatment agent, and a pressure change operation is carried out in the treatment chamber, the same pressure change operation acts on the first workpiece in a different way than on the second workpiece. After completion of the pressure change operation or during the continuation of the pressure change operation, the workpieces can be moved relative to the bath of liquid treatment agent in such a way that the first workpiece is then within the bath of liquid treatment agent, while the second workpiece is outside the bath of liquid treatment agent. If the pressure change operation now continues or a further pressure change operation is carried out, this pressure change operation now acts on the second workpiece in the same way as it previously acted on the first workpiece, and on the first workpiece in the same way as it previously acted on the second workpiece.

In this way, all workpieces (with a phase shift) are subjected to the same effect of the pressure change operation or a plurality of pressure change operations.

Preferably, it is thus provided that a pressure change operation is carried out in the treatment chamber while a first treatment region of a first workpiece is outside the bath of liquid treatment agent and a second treatment region of the same workpiece or a treatment region of a second workpiece is within the bath of liquid treatment agent.

In a particular embodiment of the invention, it is provided that at least one treatment region of at least one workpiece is immersed in the bath of liquid treatment agent or is removed from the bath of liquid treatment agent by changing the filling height of the bath of liquid treatment agent in the treatment chamber.

The change in the filling height of the bath of liquid treatment agent can be brought about, for example, by draining liquid treatment agent from the treatment chamber in order to change the filling height of the bath of liquid treatment agent in the treatment chamber or by introducing liquid treatment agent into the treatment chamber by conveying by means of a pump or by conveying by means of a pressure gradient.

In a particular embodiment of the invention, it is provided that the filling height of the bath of liquid treatment agent in the treatment chamber is maintained at a constant level by supplying liquid treatment agent into the treatment chamber or by discharging liquid treatment agent from the treatment chamber while at least one workpiece is immersed in the bath of liquid treatment agent in the treatment chamber or at least one workpiece is removed from the bath of liquid treatment agent in the treatment chamber.

In order to generate the relative movement between the at least one workpiece and the bath of liquid treatment agent, it can be provided that at least one treatment region of at least one workpiece is moved linearly and/or rotationally relative to the treatment chamber in order to immerse the treatment region in the bath of liquid treatment agent or to remove the treatment region from the bath of liquid treatment agent.

In a particular embodiment of the invention, it is provided that a relative movement of at least one treatment region of at least one workpiece relative to the bath of liquid treatment agent in the treatment chamber is synchronised with a pressure change operation in the treatment chamber.

Preferably, it is provided that a movement of at least one treatment region of at least one workpiece relative to the bath of liquid treatment agent in the treatment chamber and/or the position of at least one treatment region of at least one workpiece relative to the bath of liquid treatment agent in the treatment chamber is controlled in dependence on the pressure in the treatment chamber.

Alternatively or additionally, it can be provided that the pressure in the treatment chamber is controlled in dependence on a movement of at least one treatment region of at least one workpiece relative to the bath of liquid treatment agent in the treatment chamber and/or in dependence on the position of at least one treatment region of at least one workpiece relative to the bath of liquid treatment agent in the treatment chamber.

For example, it can be provided that at least one treatment region of at least one workpiece is immersed in the bath of liquid treatment agent when the pressure in the treatment chamber is lower than the maximum pressure (pₒ) during a pressure change operation in the treatment chamber.

In particular, it can be provided that at least one treatment region of at least one workpiece is immersed in the bath of liquid treatment agent when the pressure in the treatment chamber corresponds to the minimum pressure (pᵤ) during a pressure change operation in the treatment chamber.

The pressure in the treatment chamber at which at least one treatment region of at least one workpiece is immersed in the bath of liquid treatment agent may, for example, correspond to the boiling pressure of the treatment agent in the treatment chamber.

Alternatively or additionally, it can be provided that at least one treatment region of at least one workpiece is removed from the bath of liquid treatment agent in the treatment chamber if the pressure in the treatment chamber is higher than the minimum pressure (pᵤ) during a pressure change operation in the treatment chamber.

In particular, it can be provided that at least one treatment region of at least one workpiece is removed from the bath of liquid treatment agent in the treatment chamber when the pressure in the treatment chamber corresponds to the maximum pressure (pₒ) during a pressure change operation in the treatment chamber.

This maximum pressure (pₒ) in the treatment chamber can correspond to the ambient pressure (atmospheric pressure) or be higher than the ambient pressure.

In order to further enhance the treatment effect, it can be provided that the at least one workpiece and/or the bath of liquid treatment agent in the treatment chamber is subjected to ultrasound while the pressure in the treatment chamber is changed or during an intermediate phase between two phases in which the pressure in the treatment chamber is changed.

The combination of exposure to ultrasound and a pressure change operation, which can include cyclical pressure changes in particular, generates microflows directly on the surface of a workpiece to be treated, which results in an even greater exchange of the liquid in cavities of the workpiece to be treated.

The ultrasonic frequency is preferably at least 20 kHz, particularly preferably at least 25 kHz.

Furthermore, the ultrasonic frequency is preferably at most 120 kHz, particularly preferably at most 80 KHz.

The ultrasonic power coupled into the interior of the treatment chamber is preferably at least 5 watts per litre of liquid treatment agent in the treatment chamber, particularly preferably at least 8 watts per litre of liquid treatment agent in the treatment chamber.

Furthermore, the ultrasonic power coupled into the treatment chamber is preferably at most 20 watts per litre of liquid treatment agent in the treatment chamber, particularly preferably at most 15 watts per litre of liquid treatment agent in the treatment chamber.

By modulating the amplitude of the ultrasonic oscillations and/or by modulating the ultrasonic frequency (so-called “sweep” function), the effect of applying ultrasound to the bath of liquid treatment agent and/or the workpiece to be treated can be further intensified and the effect of the exposure to ultrasound can be evenly distributed over all surfaces of the workpiece to be treated.

In a preferred embodiment of the invention, it is provided that the pressure in the treatment chamber is increased to the ambient pressure or above the ambient pressure during a pressure change operation in the treatment chamber.

Furthermore, the pressure in the treatment chamber can be increased by feeding an inert gas and/or a high-purity gas into the treatment chamber.

Preferably, it is provided that at least one treatment region of at least one workpiece is moved relative to the treatment chamber during a pressure change operation in the treatment chamber.

In a particular embodiment of the method according to the invention, it is provided that, during the treatment of a workpiece in the treatment chamber, at least two pressure change operations are carried out which differ from one another with respect to at least one parameter, wherein the differing parameter is, for example, a minimum pressure (pᵤ) during the respective pressure change operation, a maximum pressure (pₒ) during the respective pressure change operation, a period of time during which the pressure in the treatment chamber is decreased and/or a period of time during which the pressure in the treatment chamber is increased.

In this way, one of the at least two pressure change operations can be optimised for the case in which a treatment region of a workpiece to be treated is outside the bath of liquid treatment agent in the treatment chamber during the pressure change operation, while another of the at least two pressure change operations can be optimised for the case in which the treatment region of the workpiece to be treated is within the bath of liquid treatment agent in the treatment chamber during the performance of this pressure change operation.

Furthermore, it has proven to be favourable if at least one pressure change operation comprises a plurality of cyclic pressure changes, in which the pressure in the treatment chamber is always above the boiling pressure of the treatment agent in the treatment chamber, and a holding of the pressure in the treatment chamber at the boiling pressure or below the boiling pressure of the treatment agent in the treatment chamber.

To optimise the treatment effect, it is also advantageous if at least one process parameter, for example the minimum pressure (pᵤ) during a pressure change operation, the maximum pressure (pₒ) during a pressure change operation, the period of time during which the pressure in the treatment chamber is decreased, the period of time during which the pressure in the treatment chamber is increased and/or the speed, by means of which at least one treatment region of at least one workpiece is moved relative to the bath of liquid treatment agent in the treatment chamber, is changed in dependence on measurement data from at least one sensor, for example in dependence on a temperature, a pressure and/or an (electrical) conductance.

For this purpose, it is advantageous if the apparatus for carrying out the method according to the invention comprises at least one sensor by means of which a temperature, a pressure and/or an (electrical) conductance within the treatment chamber, particularly preferably within the bath of liquid treatment agent in the treatment chamber, is determinable.

It has proven to be particularly favourable if at least one treatment region of at least one workpiece is heated during a pressure change operation and/or outside a pressure change operation.

It is particularly favourable if the treatment region concerned of the workpiece is heated while the treatment region of the workpiece is outside the bath of liquid treatment agent.

In this case, the treatment region of the workpiece to be treated is heated selectively or directly outside the bath of liquid treatment agent and not indirectly by heating the liquid treatment agent. This results in a very rapid localised increase in temperature at the workpiece to be treated.

In a preferred embodiment of the invention, it is provided that the at least one treatment region of the at least one workpiece is heated by exposing the workpiece to electromagnetic radiation, to a plasma, to hot air, to a superheated steam, to a dry steam and/or to a hot liquid medium, for example to a hot cleaning medium.

The wavelength of the electromagnetic radiation can be in the infrared range or microwave range in particular.

The use of electromagnetic radiation with a wavelength of preferably at least 1 μm, particularly preferably at least 1.8 μm, and/or preferably at most 3 μm, particularly preferably at most 2.6 μm, is particularly suitable.

A heating lamp or laser, for example, can be used for the exposure to electromagnetic radiation.

If the at least one workpiece is subjected to a dry vapour, a supercritical dry vapour is preferably used.

The temperature of the superheated steam and/or the dry steam to which the at least one treatment region of the at least one workpiece is exposed is preferably at least 200° C. and/or preferably at most 800° C.

The at least one treatment region of the at least one workpiece can be heated outside the bath of liquid treatment agent, preferably with radiant heat and/or with convection heat.

The selective, localised heating of at least one treatment region of at least one workpiece to be treated enables selective, localised cleaning of at least one critical region of the workpiece.

Preferably, it is provided that at least one treatment region of at least one workpiece is heated at least locally to a temperature which is above the boiling temperature of the treatment agent at a minimum pressure (pᵤ) reached during a pressure change operation in the treatment chamber.

In order to intensify the treatment effect, it can be provided that the heating of the at least one treatment region of the at least one workpiece, the immersion of the heated treatment region in the bath of liquid treatment agent and/or the performance of a pressure change operation in the treatment chamber are repeated one or more times.

Preferably, it is provided that the at least one treatment region of the at least one workpiece is heated such that the temperature of the treatment region concerned is above the temperature of the liquid treatment agent in the bath of liquid treatment agent in the treatment chamber.

A pressure boost in the treatment chamber can be used to draw in hot process streams.

The method according to the invention is suitable, for example, for carrying out a cleaning operation or a passivation operation on a workpiece to be treated.

The liquid treatment agent is preferably an aqueous solution.

Alternatively, an organic solvent can also be used as a liquid treatment agent.

The organic solvent preferably has a high evaporation temperature.

As an organic solvent, for example, the solvent offered by ZESTRON Europe (a Business Division of Dr. O. K. Wack Chemie GmbH), Bunsenstrasse 6, 85053 Ingolstadt, Germany, under the name “ZESTRON® HC” can be used.

If a passivating agent is to be used as a liquid treatment agent, the passivating agent is preferably an aqueous solution to which at least one acid has been added.

For example, it can be provided that the passivating agent comprises citric acid.

The proportion of citric acid can preferably be at least 4 wt. % and/or preferably at most 10 wt. %.

Alternatively or additionally, it can be provided that the passivating agent comprises phosphoric acid and/or nitric acid.

For example, an aqueous solution of nitric acid can be used as a passivating agent, containing nitric acid in a proportion of at least 20 vol. % and/or of at most 55 vol. %, in particular of at most 45 vol. %, particularly preferably of at most 25 vol. %.

Alternatively, it can be provided that the passivating agent contains phosphoric acid in a concentration of at least 1.5 vol. % and/or at most 3 vol. %.

In a particularly preferred embodiment of a passivation process according to the invention, it is provided that the passivating agent is an aqueous solution of phosphoric acid and nitric acid, wherein the passivating agent contains phosphoric acid in a concentration of 1.5 vol. % to 3 vol. % and nitric acid in a concentration of 0.1 vol. % to 0.5 vol. %.

Furthermore, the passivating agent can contain non-ionic surfactants in a concentration of preferably 0.05 vol. % to 0.5 vol. %.

The aqueous solution is preferably based on deionised water (fully desalinated water) with a maximum electrical conductivity of 10 μS/cm.

In accordance with an embodiment of the invention, an apparatus for treating workpieces is provided which makes it possible to achieve an enhanced treatment effect when carrying out a pressure change operation on a workpiece to be treated.

In accordance with an embodiment of the invention, an apparatus for treating workpieces is provided which comprises the following:
a treatment chamber for receiving at least one workpiece and a bath of a liquid treatment agent;
a pressure changing apparatus for decreasing and increasing the pressure in the treatment chamber while treatment agent is in the treatment chamber; and
a device for at least partially immersing at least one treatment region of at least one workpiece in the bath of liquid treatment agent.

In particular, the device for at least partially immersing at least one treatment region of at least one workpiece can comprise a fill level changing apparatus and/or a workpiece moving apparatus.

Particular embodiments of such an apparatus according to the invention for treating workpieces have already been explained above in conjunction with particular embodiments of the method according to the invention for treating a workpiece.

The apparatus according to the invention for treating workpieces is suitable in particular for carrying out the method according to the invention for treating a workpiece.

The method according to the invention for treating a workpiece is preferably carried out by means of the apparatus according to the invention for treating workpieces.

A preferred embodiment of the apparatus according to the invention comprises a heating apparatus by means of which at least one treatment region of at least one workpiece is heatable while the treatment region concerned of the workpiece is outside the bath of liquid treatment agent in the treatment chamber.

By means of such an apparatus, at least one treatment region of at least one workpiece to be treated is heatable while the treatment region is not immersed in the liquid treatment agent.

The treatment region of the workpiece to be treated is thus heated selectively or directly outside the bath of liquid treatment agent and not indirectly by heating the liquid treatment agent. This results in a very rapid localised increase in temperature in the treatment region of the workpiece to be treated.

The heating apparatus is preferably configured such that at least one treatment region of at least one workpiece is heatable by means of the heating apparatus by applying electromagnetic radiation, a plasma, hot air, superheated steam, dry steam and/or a hot liquid medium, for example a cleaning medium, to the treatment region concerned of the workpiece.

In order to protect sensitive parts of the heating apparatus, it is preferably provided that at least a part of the heating apparatus is separable from a vapour space of the treatment chamber by means of a separating apparatus.

In particular, such a separating apparatus can comprise one or more flaps.

By mechanically separating the heating apparatus from the vapour space of the treatment chamber, sensitive components of the heating apparatus are protected from being exposed to vapour and/or foam from the vapour space of the treatment chamber.

A preferred embodiment of the apparatus according to the invention comprises at least one sensor for detecting the position of at least one workpiece, for detecting a movement of at least one workpiece relative to the treatment chamber and/or for detecting at least one parameter of the bath of liquid treatment agent, for example a temperature or a (electrical) conductance of the bath of liquid treatment agent.

The movement of the at least one workpiece relative to the treatment chamber can comprise at least one rotational degree of freedom of movement and/or at least one linear degree of freedom of movement.

In a particular embodiment of the apparatus according to the invention, it is provided that the apparatus comprises a control apparatus by means of which the pressure changing apparatus is controllable in dependence on a signal from at least one sensor for detecting the position of at least one workpiece, for detecting a movement of at least one workpiece relative to the treatment chamber and/or for detecting at least one parameter of the bath of liquid treatment agent, for example a temperature or a (electrical) conductance of the bath of liquid treatment agent.

In such an embodiment of the apparatus according to the invention, it is possible to control one or more pressure change operations in the treatment chamber in dependence on the position of the at least one workpiece and/or in dependence on the movement of the at least one workpiece relative to the treatment chamber.

In order to immerse the at least one treatment region of at least one workpiece in the bath of liquid treatment agent, a relative movement is produced between the heated workpiece on the one hand and the bath of liquid treatment agent in the treatment chamber on the other.

It can be provided that the workpiece is moved relative to the treatment chamber when it is immersed in the bath of liquid treatment agent.

An apparatus by means of which the method according to the invention is executable therefore preferably comprises a workpiece moving apparatus, by means of which the workpiece is at least partially immersible in the bath of liquid treatment agent.

The workpiece can be moved linearly and/or rotationally relative to the treatment chamber.

To make this possible, a workpiece moving apparatus with at least one linear degree of freedom of movement and/or with at least one rotational degree of freedom of movement is preferably provided.

Alternatively or in addition to this, immersion of the workpiece in the bath of liquid treatment agent can also be achieved by changing the filling height of the bath of treatment agent in the treatment chamber when the workpiece is immersed in the bath of liquid treatment agent, particularly preferably by increasing it.

The filling height of the bath of liquid treatment agent in the treatment chamber can be decreased accordingly when removing the workpiece from the bath of liquid treatment agent.

In order to remove liquid treatment agent adhering to the at least one workpiece from the workpiece after it has been removed from the bath of liquid treatment agent, a particular embodiment of the method provides that the pressure in the treatment chamber is reduced when the at least one workpiece has been at least partially, preferably completely, removed from the bath of liquid treatment agent, so that liquid treatment agent arranged on a surface and/or in at least one capillary of the at least one workpiece is vaporised.

If the workpiece to be treated has at least one capillary, it can be provided that the pressure in the treatment chamber is reduced if the capillary of the workpiece in question is arranged and oriented in the treatment chamber in such a way that an upper end of the capillary is arranged above a bath level of the liquid treatment agent in the treatment chamber and a lower end of the capillary is arranged below the bath level of the liquid treatment agent in the treatment chamber. This ensures that the capillary concerned is easily fillable with liquid treatment agent rising from the bath of liquid treatment agent into the capillary.

The workpiece is preferably moved relative to a bath level of the liquid treatment agent in the treatment chamber during a pressure change operation in the treatment chamber and/or between two phases of the treatment in which the pressure in the treatment chamber is changed.

In particular, if the workpiece is heated outside the bath of liquid treatment agent and then the heated workpiece is partially immersed in the bath of liquid treatment agent, it can be achieved by moving the workpiece relative to the bath level of the liquid treatment agent that the region of the interface between the liquid treatment agent on the one hand and the heated workpiece on the other hand, at which the temperature of the liquid treatment agent is raised locally above the boiling temperature of the treatment agent at the respective pressure prevailing in the treatment chamber by the transfer of heat from the workpiece into the liquid treatment agent, is displaced over the surface of the workpiece to be treated, so that different regions of the workpiece to be treated are successively exposed to the treatment by a bubble formation and a bubble implosion.

During a pressure change operation in the treatment chamber, the maximum pressure (pₒ) in the treatment chamber is preferably lower than the ambient pressure. For example, it can be provided that the maximum pressure (pₒ) in the treatment chamber during the cyclic pressure change operation is at most 900 mbar, in particular at most 800 mbar, particularly preferably at most 700 mbar.

In a particular embodiment of the invention, it is provided that the minimum pressure (pᵤ), to which the pressure in the treatment chamber is reduced, is changed during a pressure change operation in the treatment chamber and/or that the minimum pressure (pᵤ), to which the pressure in the treatment chamber is reduced during different pressure change operations in the treatment chamber, is different for different pressure change operations. The different minimum pressures in different phases of a pressure change operation or during different pressure change operations ensure that bubbles are formed in different regions of an immersed workpiece.

In the method according to the invention for treating a workpiece, at least one workpiece to be treated can be alternately and/or cyclically immersed to different extents in the bath of liquid treatment agent during the treatment, completely immersed in the liquid treatment agent and/or completely removed from the bath of liquid treatment agent.

In a particular embodiment of the invention, at least one region of a surface of a workpiece to be treated, which is in a gas phase of the interior of the treatment chamber, above the bath level of the liquid treatment agent, is heated.

Preferably, at least one heated treatment region of a workpiece to be treated is immersed in the bath of liquid treatment agent after the heating. The surface of the heated treatment region of the workpiece to be treated is warmer for a certain period of time than the liquid treatment agent in which the heated treatment region of the workpiece to be treated is immersed.

Heat is transferred from a heated workpiece to the liquid treatment agent at the interface between the workpiece and the liquid treatment agent.

If the pressure in the interior of the treatment chamber is lowered during a pressure change operation, the vapour pressure of the treatment agent is preferably undershot at least in the heated volume of the liquid treatment agent adjacent to a heated treatment region of a workpiece. Vapour bubbles thus form, which preferably implode in a subsequent phase of increased pressure in the treatment chamber. Thus transient cavitation occurs directly on the surface of the workpiece to be treated, which causes intensive treatment, for example cleaning, of the workpiece to be treated.

Alternatively or in addition to this, the formation and collapse of the vapour bubbles forces an exchange of a medium (which can be a gaseous medium or a liquid medium) located in a cavity of the workpiece to be treated.

During a treatment operation, the surfaces of a workpiece to be treated can be repeatedly immersed in the bath of liquid treatment agent and removed from the bath of liquid treatment agent at different pressure levels.

Furthermore, the surfaces of a workpiece to be treated can be repeatedly heated and cooled in cycles during a treatment operation.

Due to the changing pressure and temperature conditions, the pressure change treatment of the workpiece to be treated takes place under different conditions for the formation and collapse of vapour bubbles, whereby a high treatment effect, in particular a high cleaning effect, is achievable for different geometries of the workpiece to be treated and for different types and degrees of contamination.

The strongest treatment effect is achieved directly below the bath level of the bath of liquid treatment agent, i.e. directly below the interface between the liquid phase and the gas phase in the interior of the treatment chamber.

If a pressure change operation is carried out while the workpiece to be treated is at least partially immersed in the bath of liquid treatment agent, the pressure in the treatment chamber only needs to be reduced during the pressure change operation to such an extent that in the region of the liquid treatment agent which is directly adjacent to a heated treatment region of a workpiece to be treated and has been heated by the heated workpiece, the vaporisation temperature of the treatment agent is reached at the minimum pressure (pᵤ) during a pressure change operation.

The colder treatment agent in the treatment chamber, which is not in contact with the workpiece to be treated, does not have to be vaporised in this case. This generates a significantly smaller amount of vapour, which reduces the load on a pressure-reducing apparatus, in particular a vacuum pump, used to generate the vacuum in the treatment chamber.

In addition to carrying out a pressure change operation while the workpiece to be treated is at least partially, preferably completely, immersed in the bath of liquid treatment agent, a pressure change operation is also carried out while the workpiece to be treated is at least partially, preferably completely, removed from the bath of liquid treatment agent.

The surfaces of the workpiece to be treated that are no longer immersed in the bath of liquid treatment agent are wetted with liquid treatment agent by the previous immersion process.

Alternatively or in addition to this, surfaces of the workpiece to be treated can be wetted with liquid treatment agent by condensation of vapour of the treatment agent from the gas phase in the treatment chamber on the surfaces of the workpiece and/or by applying liquid treatment agent from spray nozzles in the treatment chamber to surfaces of the workpiece to be treated.

By reducing the pressure in the gas phase of the interior of the treatment chamber during a pressure change operation, the liquid treatment agent is vaporised on these surfaces of the workpiece to be treated, thereby producing a cleaning effect on the surfaces concerned of the workpiece to be treated.

In particular, it can be provided that the liquid present in at least one bore and/or at least one capillary of a workpiece to be treated is boiled out.

This means that the workpiece to be treated can be prepared for a subsequent treatment in the immersed state in the bath of liquid treatment agent.

By carrying out at least one pressure change operation on a treatment region of a workpiece to be treated which has been removed from the bath of liquid treatment agent and subsequently carrying out a pressure change operation on the same treatment region of the workpiece to be treated after the workpiece has been immersed in the bath of liquid treatment agent, a high level of liquid exchange is achieved at the treatment region concerned of the workpiece to be treated.

If an apparatus for carrying out the method according to the invention comprises a workpiece moving apparatus, the workpiece moving apparatus can in particular comprise a linear moving apparatus and/or a pivot mounting.

For example, a pivot mounting can be used to pivot a workpiece to be treated through an angle of less than 360° about an axis of rotation.

Alternatively or in addition to this, it can be provided that a rotary movement of a workpiece to be treated through an angle of 360° or more about an axis of rotation is executable by means of such a pivot mounting.

In addition or as an alternative to a workpiece moving apparatus, an apparatus for carrying out the method according to the invention can comprise a fill level changing apparatus for changing the filling height of the liquid treatment agent in the treatment chamber.

A reduction in the filling height of the liquid treatment agent in the treatment chamber can be achieved, for example, by opening a valve at the bottom of the treatment chamber.

An increase in the filling height of the liquid treatment agent in the treatment chamber can be achieved, for example, by generating a vacuum in the treatment chamber or by conveying liquid treatment agent from a storage container into the treatment chamber by means of a pump until the desired filling height of the liquid treatment agent in the treatment chamber is reached.

The treatment chamber is preferably only partially filled with liquid treatment agent, so that the following phases are formed in the treatment chamber:
a gas phase, which is filled in particular with a vapour of the treatment agent and/or with air;
a liquid phase, which is filled in particular with liquid treatment agent; and
an interface region, where the gas phase and the liquid phase adjoin each other.

The filling height up to which the treatment chamber is filled with the liquid treatment agent is preferably flexibly adjustable. As a result, the gas phase and the liquid phase in the interior of the treatment chamber differ in size depending on the fill level of the liquid treatment agent in the treatment chamber. The interface region can be arranged on the surface of a workpiece partially immersed in the bath of liquid treatment agent at different regions of the workpiece to be treated, depending on the fill level of the liquid treatment agent in the treatment chamber.

Further features and advantages of the invention are the subject of the following description and the illustration of exemplary embodiments.

### BRIEF DESCRIPTION OF THE DRAWINGS

FIG. 1 shows a schematic representation of an apparatus for treating workpieces which comprises a treatment chamber for receiving at least one workpiece and a bath of a liquid treatment agent, a pressure changing apparatus for cyclically changing the pressure in the treatment chamber while treatment agent is in the treatment chamber, a heating apparatus by means of which the at least one workpiece can be heated at least in certain regions while the workpiece in question is at least partially outside the bath of liquid treatment agent, and a device for at least partially immersing the heated workpiece in the bath of liquid treatment agent, wherein the pressure changing apparatus comprises, for example, a separator and a vacuum pump as vacuum generator; and

FIG. 2 shows a diagram showing the pressure curve in the treatment chamber in dependence on the treatment time during a cyclical pressure change operation.

### DETAILED DESCRIPTION OF THE INVENTION

Identical or functionally equivalent elements are denoted with the same reference signs in all Figures.

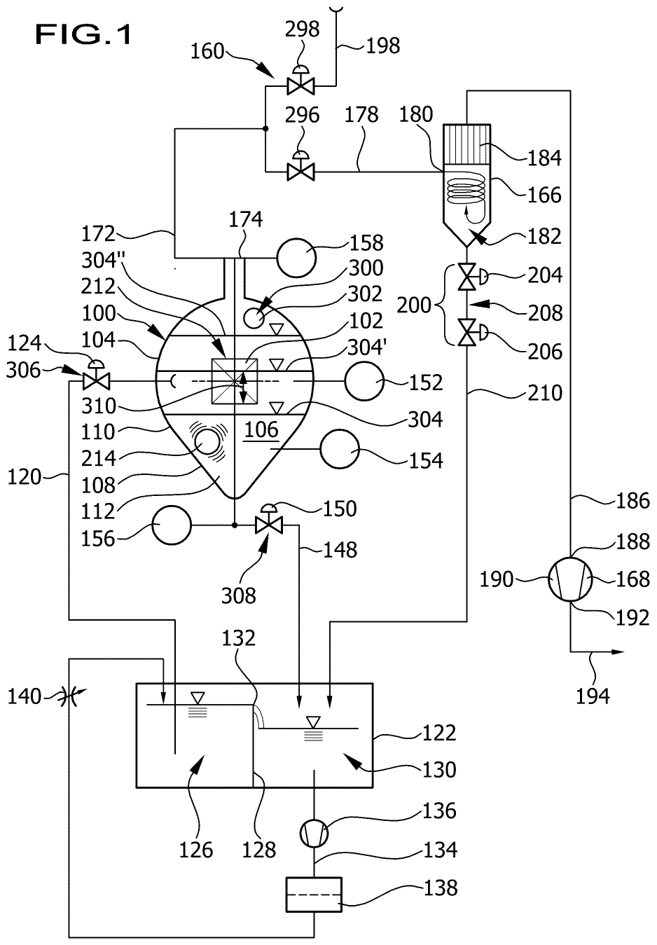

An apparatus for treating workpieces 102, shown schematically in FIG. 1 and denoted 100 as a whole, comprises a treatment chamber 104 for receiving at least one workpiece 102 in an interior of the treatment chamber 104, which is surrounded by a wall 108 of the treatment chamber.

In order to be able to introduce a workpiece 102 into the interior of the treatment chamber 104, it is preferably provided that the treatment chamber 104 comprises a tank 110 which is fillable with a treatment agent 112, for example a passivating agent 114, up to a maximum level 118 and is closable by means of a cover 116.

In order to be able to fill the treatment chamber 104 with treatment agent, for example passivating agent, the interior 106 of the treatment chamber 104 is connected to a storage container 122 by means of a supply line 120.

The supply line 120 is openable or closable by means of a valve 124 arranged in the same.

The feed line 120 opens into a clean area 126 of the storage container 122, which is filled with a treatment agent prepared for a treatment operation in the treatment chamber 104, for example a passivating agent.

The clean area 126 is separated from a dirty area 130 of the storage container 122 by a partition wall 128.

An overflow 132 is located at the upper edge of the partition wall 128, by means of which treatment agent can pass from the clean area 126 into the dirty area 130.

The treatment agent in the dirty area 130 is processed for use in the treatment chamber 104 by transferring it by means of a filtration line 134 from the dirty area 130 of the storage container 122 to the clean area 126 of the storage container 122.

A filtration pump 136, a filter 138 and a flow limiter 140 are arranged in the filtration line 134.

Emptying of the treatment agent from the interior 106 of the treatment chamber 104 is possible by means of an emptying line 148, which is preferably connected at a lowest point of the interior 106 of the treatment chamber 104 and opens out into the dirty area 130 of the storage container 122.

The emptying line 148 is openable and closable by means of a valve 150 arranged in the same.

To monitor the treatment operation in the treatment chamber 104, the treatment chamber 104 is provided with various sensors, in particular with a pressure sensor 152, a temperature sensor 154, a lower level sensor 156 and/or an upper level sensor 158.

The lower level sensor 156 is used to determine whether the interior 106 of the treatment chamber 104 has been completely emptied of treatment agent.

The upper level sensor 158 is used to determine whether the interior 106 of the treatment chamber 104 is completely filled with liquid treatment agent.

As an alternative or in addition to the sensors mentioned above and shown in FIG. 1, the apparatus 100 for treating workpieces 102 can comprise one or more of the sensors mentioned in the above description.

In order to be able to cyclically change the pressure in the treatment chamber 104, the apparatus 100 for treating workpieces 102 further comprises a pressure changing apparatus 160, which in the illustrated exemplary embodiment comprises an evacuation valve 296, a separator 166 and a vacuum generator 168.

The evacuation valve 296 is connected to a pressure change outlet 174 of the treatment chamber 104 by means of a pressure change line 172.

Furthermore, the evacuation valve 296 is connected to an inlet 180 of the separator 166 by means of an evacuation line 178.

Gas originating from the interior 106 of the treatment chamber 104 and loaded with a vapour of the treatment agent and/or with droplets of the treatment agent passes through the inlet 180 into the interior 182 of the separator 166, which can be configured, for example, as a cyclone in order to separate droplets contained in the incoming gas stream from the gas stream by centrifugal action.

Furthermore, the separator 166 can include a condensation apparatus 184 comprising, for example, baffle plates and/or a support mesh and/or a cooled heat exchanger on which vapour from the treatment agent can condense and thus be separated from the gas stream flowing through the separator 166.

The gas flow freed from droplets and/or vapour of the treatment agent by means of the separator 166 passes through a suction line 186 to a suction-side inlet 188 of the vacuum generator 168.

The vacuum generator 168 can, for example, be configured as a vacuum pump 190, preferably as a positive displacement vacuum pump.

The gas flow then passes by means of a pressure-side outlet 192 of the vacuum generator 168 into a pressure line 194 and from there, for example, into the surroundings of the apparatus 100.

The pressure changing apparatus 160 further comprises a vent valve 298. The vent valve 298 is connected to the pressure change outlet 174 of the treatment chamber 104 by means of the (branching) pressure change line 172.

Furthermore, the vent valve 298 is connected to a vent line 198, through which ambient air is feedable to the vent valve 298.

The pressure changing apparatus 160 is switchable from an evacuation state, in which the evacuation valve 296 connected to the evacuation line 178 is open and the vent valve 298 connected to the vent line 198 is closed, to an air supply, in which the vent valve 298 connected to the vent line 198 is open and the evacuation valve 296 connected to the evacuation line 178 is closed.

Furthermore, the pressure changing apparatus 160 can be switched to a holding state in which both the evacuation valve 296 and the vent valve 298 are closed, so that the pressure in the treatment chamber 104 is kept substantially constant.

In principle, the evacuation valve 296 and/or the vent valve 298 can be switched between the open and closed states in any way, for example mechanically, electromechanically, pneumatically, hydraulically or electromagnetically.

The apparatus 100 further comprises a heating device 300, by means of which the at least one workpiece 102 is heatable at least in certain areas while the workpiece 102 concerned is at least partially outside the bath 106 of the treatment agent 112.

Such a heating apparatus 300 can in particular comprise a radiation source 302 arranged in the interior of the treatment chamber 104.

The radiation source 302 is configured such that the at least one workpiece 102 is heatable by exposing the workpiece 102 to electromagnetic radiation.

The electromagnetic radiation can have a wavelength in the infrared range or microwave range, for example.

The radiation source 302 can be configured, for example, as a heating lamp or as a laser.

The interior of the treatment chamber 104 is filled with the bath 106 of the treatment agent 112 up to a filling height at which a bath level 304 of the bath 106 of the treatment agent 112 is located.

The height of the bath level 304 in the treatment chamber 104 is adjustable to a desired height by actuating the valve 124 in the supply line 120 and/or by actuating the valve 150 in the emptying line 148.

Opening the valve 124 in the supply line 120 while the valve 150 in the emptying line 148 is closed raises the height of the bath level 304.

The height of the bath level 304 is lowered by opening the valve 150 in the emptying line 148 while the valve 124 in the supply line 120 is closed.

Three different heights of the bath level 304 are shown schematically in FIG. 1.

The lowest bath level 304 is at a height at which the workpiece 102 to be treated is completely removed from the bath 106 of the treatment agent 112.

The bath level 304′ is at a greater height than the bath level 304. When the treatment chamber 104 is filled with the liquid treatment agent 112 up to the bath level 304′, the workpiece 102 to be treated is partly below the treatment level 304′, within the treatment bath 106, and partly above the treatment level 304′, i.e. outside the treatment bath 106.

When the treatment chamber 104 is filled with the liquid treatment agent up to the bath level 304″, the workpiece 102 to be treated is completely immersed in the bath 106 of liquid treatment agent 112.

The radiation source 302 is preferably located above the uppermost bath level 304″.

The valves 124 and 150 form components of a fill level changing device 306 of the apparatus 100, with which the level of the liquid treatment agent 112 in the treatment chamber 104 and thus the position of the bath level 304 is changeable.

The workpiece 102 to be treated can be removed from the bath 106 of liquid treatment agent by lowering the fill level using the fill level changing apparatus 306.

By increasing the fill level of the liquid treatment agent 112 in the treatment chamber 104, the workpiece 102 to be treated can be immersed in the bath 106 of liquid treatment agent 112.

The fill level changing apparatus 306 thus forms a component of a device 308 for at least partially immersing the workpiece 102 to be treated in the bath 106 of liquid treatment agent 112.

The device 308 for at least partially immersing the workpiece 102 in the bath 106 of liquid treatment agent 112 can comprise, as an alternative or in addition to the fill level changing apparatus 306, a workpiece moving apparatus (not shown) by means of which the workpiece 102 to be treated is at least partially immersible in the bath 106 of liquid treatment agent 112 and/or at least partially removable from the bath 106 of liquid treatment agent 112.

Such a workpiece moving apparatus can comprise a linear moving apparatus by means of which the at least one workpiece 102 is movable in a linear direction of movement, for example in the direction of the vertical 310.

Alternatively or in addition to this, the workpiece moving apparatus can comprise a moving apparatus by means of which the at least one workpiece is movable rotationally, for example is rotatable about a—preferably horizontally oriented—axis of rotation.

Such a rotary movement can, for example, immerse a part of the workpiece 102 to be treated in the bath 106 of liquid treatment agent 112, while at the same time another part of the workpiece 102 to be treated is removed from the bath 106 of liquid treatment agent 112.

In principle, however, the workpiece moving apparatus can have any number of degrees of freedom of movement along which the at least one workpiece is movable.

A particularly simple structure of the workpiece moving apparatus is achieved if the workpiece moving apparatus has only one degree of freedom of movement, wherein this degree of freedom of movement can in particular be a linear degree of freedom of movement or a rotational degree of freedom of movement.

All switchable valves of the apparatus 100, the heating device 300, the fill level changing apparatus 306 and, if applicable, also the workpiece moving apparatus as well as the sensors, for example the pressure sensor 152, the temperature sensor 154, the lower level sensor 156 and the upper level sensor 158, are connected by means of signal and control lines (not shown) to a control apparatus (not shown) of the apparatus 100 for treating workpieces 102, so that the control apparatus can receive signals from the sensors and process them further, can switch the switchable valves from one state to the other state and can control the heating device 300, the fill level changing apparatus 306 and, if necessary, the workpiece moving apparatus.

The control apparatus of the apparatus 100 is preferably programmable, so that a control program for controlling a process for treating workpieces 102 is executable by means of the control apparatus and the sensors and actuators controlled by it.

Condensate accumulated in the separator 166 during operation of the apparatus 100 can be removed from the interior 182 of the separator 166 by means of a condensate airlock 200.

The condensate airlock 200 comprises a first airlock valve 204 connected to a condensate outlet 202 of the separator 166, a second airlock valve 206 arranged downstream of the first airlock valve 204, and an airlock chamber 208 arranged between the first airlock valve 204 and the second airlock valve 206.

The condensate separated in the separator 166 enters the airlock chamber 208 of the condensate airlock 200 by opening the first airlock valve 204 while the second airlock valve 206 is closed.

After the airlock chamber 208 has been filled with condensate, the first airlock valve 204 is closed and the second airlock valve 206 is opened.

The second airlock valve 206 is connected to the dirty area 130 of the storage container 122 by means of a condensate line 210, so that the condensate separated in the separator 166 enters the storage container 122 by means of the condensate airlock 200.

By means of the apparatus 100 described above for treating workpieces, a method for treating, for example passivating, workpieces is carried out as follows:

Before passivating a workpiece 102, all surfaces of the workpiece 102 must be free of all filmic, particulate and other contaminants and residues of cleaning agents. Before the passivation operation, the workpiece 102 is therefore cleaned intensively, followed by rinsing of all surfaces of the workpiece 102.

The treatment chamber 104 of the apparatus 100 is provided with a closing device, for example with a cover 116.

This closing device enables the treatment chamber 104 to be sealed airtightly.

When the closing device is open, in particular when the cover 116 is lifted off, the workpiece 102 to be treated is introduced into the interior 106 of the treatment chamber 104.

The workpiece 102 can be held on a workpiece holder 212.

After the workpiece 102 has been placed in the interior 106 of the treatment chamber 104, the treatment chamber 104 is sealed airtightly by means of the closing device.

If no bath of the treatment agent, in particular of the passivating agent, is yet present in the interior 106 of the treatment chamber 104, a desired quantity of liquid treatment agent is sucked from the storage container 122 through the supply line 120. The valve 124 in the supply line 120 is open for this purpose.

The pressure changing apparatus 160 is initially in the evacuation state, in which the evacuation valve 296 is open and the vent valve 298 is closed. The vacuum generator 168, in particular the vacuum pump 190, is in operation and draws gas, which can be loaded with vapour of the treatment agent and with droplets of the treatment agent, through the pressure change line 172, the evacuation line 178, the separator 166 and the suction line 186 to the suction-side inlet 188 of the vacuum generator 168.

Droplets of the treatment agent carried along with the extracted gas are separated in the separator 166. Furthermore, the vapour of the treatment agent carried along with the gas condenses out in the condensing apparatus 184.

The liquid treatment agent that has collected in the lower region of the separator 166 can be fed to the dirty area 130 of the storage tank 122 by means of the condensate airlock 200 and the condensate line 210 when a predetermined fill level is reached or after a predetermined operating time interval.

The separator 166 can also serve as a vacuum tank.

By drawing liquid treatment agent 112 from the supply tank 122, the treatment chamber 104 is filled with a bath 106 of liquid treatment agent 112 up to a bath level 304, wherein the bath level 304 is initially below the at least one workpiece 102 to be treated.

A treatment phase then begins, in the course of which at least one treatment region of the at least one workpiece 102 to be treated is immersed at least once in the bath 106 of the treatment agent 112 and a cyclic pressure change operation is carried out in the treatment chamber 104 while the treatment region of the at least one workpiece 102 to be treated is immersed in the bath 106 of the treatment agent 112.

At the beginning of the treatment phase, the heating device 306 is switched by the control apparatus to an active state, in which the heating device 300 at least partially heats the workpiece 102 to be treated, for example by applying electromagnetic radiation.

In this case, the at least one workpiece 102 to be treated can be heated locally, for example to a temperature of at least about 200° C. and at most about 800° C., at a surface region of the workpiece 102 on which the heating device 300 acts.

After the desired heating time has elapsed or after the desired heating temperature has been reached, the heated surface region of the heated workpiece 102 is immersed in the bath 106 of the treatment agent 112.

The workpiece 102 is immersed in the bath 106 by a relative movement between the workpiece 102 and the bath level 304 of the bath 106.

This relative movement can be produced, for example, by the control apparatus actuating the fill level changing apparatus 306 to supply additional treatment agent from the supply tank 122 to the interior of the treatment chamber 104, thereby raising the bath level 304 to a higher position 304′, at which the heated workpiece 102 is partially immersed in the bath 106 of liquid treatment agent 112, or to an even higher position 304″, at which the workpiece 102 is fully immersed in the bath 106 of liquid treatment agent 112.

Alternatively or in addition thereto, the relative movement between the workpiece 102 and the bath level 304 can also be effected by the control apparatus actuating the workpiece moving apparatus, whereby at least the heated surface region of the at least one workpiece 102 to be treated enters the bath 106 of liquid treatment agent 112.

The movement of the workpiece 102 to be treated can comprise at least one linear degree of freedom of movement, for example parallel to the vertical 310, and/or at least one rotational degree of freedom of movement, for example a rotation about a preferably horizontally oriented axis of rotation.

The heated surface region of the workpiece 102 is warmer for a certain time than the liquid treatment agent in which this surface region of the workpiece 102 is immersed. The heat introduced into the heated workpiece is transferred from the workpiece 102 to the treatment agent 112 at the interface between the workpiece 102 and the treatment agent 112.

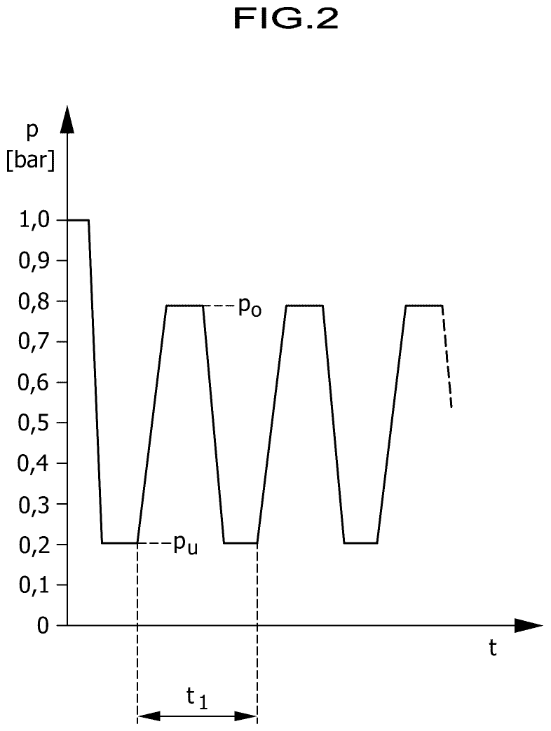

Now the pressure in the interior 106 of the treatment chamber 104 is decreased from an initial pressure (for example from atmospheric pressure at approximately 1.0 bar) to a lower pressure value pᵤ. The lower pressure value pᵤ is selected such that the vapour pressure of the heated treatment agent 112 in the region of the interface between the liquid treatment agent 112 and the heated surface region of the workpiece 102 is undershot. After reaching the lower pressure value pᵤ, the pressure in the treatment chamber 104 is cyclically changed during a pressure change period, i.e. increased from the lower pressure value pᵤ to an upper pressure value pₒ and then lowered again to the lower pressure value pᵤ (see FIG. 2).

This process can be repeated in particular periodically.

Between the pressure increase phases and pressure reduction phases, the pressure in the treatment chamber 104 can remain at the lower pressure value pᵤ or at the upper pressure value pₒ by switching the pressure changing apparatus 160 to a holding state in which the evacuation valve 296 and the vent valve 298 are closed.

To increase the pressure in the treatment chamber 104, the pressure changing apparatus 160 is switched by the control apparatus to the air supply state, in which the evacuation valve 296 is closed and the vent valve 298 is open, so that ambient air enters the interior 106 of the treatment chamber 104 through the vent line 198 and the pressure change line 172.

The lower pressure value pᵤ is preferably at least 20 mbar and/or preferably at most 500 mbar, in particular at most 300 mbar.

The upper pressure value pₒ is preferably at least 700 mbar and/or preferably at most 1 bar.

The cycle duration t₁ of a complete pressure cycle is preferably at least 1 second, in particular at least 3 seconds, particularly preferably at least 5 seconds.

Furthermore, the cycle duration t₁ of a complete pressure cycle is preferably at most 30 seconds, particularly preferably at most 10 seconds.

The initial pressure in the treatment chamber 104 prior to immersion of the heated surface region of the workpiece 102 in the bath 106 of liquid treatment agent 112 can also be below atmospheric pressure, preferably at a maximum of 0.8 bar, in order to be able to quickly fall below the vapour pressure of the treatment agent 112 at the interface with the heated surface region of the workpiece 102 after immersion.

If the workpiece 102 comprises narrow tubes, so-called capillary tubes, it is favourable if these capillary tubes are oriented substantially vertically, with one end of each tube projecting into the treatment agent 112 and the opposite end of the tube projecting into the gas-filled region of the interior of the treatment chamber 104. The hydrostatic pressure then sucks the treatment agent into the capillary tubes.

This process reliably exchanges the fluid that is present on the surface of the workpiece 102 or in holes or capillaries of the workpiece 102 as a result of preliminary processes.

This ensures during the treatment operation that the treatment agent can completely wet all surfaces of the workpiece 102, so that the desired treatment is carried out on all surfaces of the workpiece 102.

The pressure change operation, which comprises numerous pressure change cycles, is carried out during a pressure change time of preferably at least 1 minute, in particular at least 5 minutes, particularly preferably at least 10 minutes.

Furthermore, the pressure change operation is preferably carried out during a pressure change time of at most 60 minutes, in particular at most 30 minutes, particularly preferably at most 20 minutes.

If the treatment operation to be carried out is a passivation operation, a passivating agent is used as the treatment agent.

The passivating agent preferably has the following chemical composition:

The passivating agent is based on deionised water with a maximum electrical conductivity of 10 μS/cm.

The passivating agent also contains phosphoric acid in a concentration of 1.5 vol. % to 3 vol. %, nitric acid in a concentration of 0.1 vol. % to 0.5 vol. % and non-ionic surfactants in a concentration of 0.05 vol. % to 0.5 vol. %.

Alternatively, an aqueous solution of nitric acid can be used as a passivating agent, for example, containing nitric acid in a proportion of at least 20 vol. % and at most 55 vol. %, in particular at most 45 vol. %, particularly preferably at most 25 vol. %.

Furthermore, an aqueous solution of citric acid can be used as an alternative passivating agent, wherein the proportion of citric acid is preferably at least 4 wt. % and/or preferably at most 10 wt. %.

The pH value of the passivating agent is preferably at least 1.8 and/or preferably at most 2.2.

The cyclic pressure change in the treatment chamber 104 generates bubbles directly on the immersed, previously heated surface region of the workpiece 102 or the multiple workpieces 102. Some of these bubbles are stable and change their volume as the pressure changes; the volume of the bubbles decreases as the pressure increases and increases as the pressure decreases.

These volume changes generate microflows in the bath 106 from the liquid treatment agent 112 and in particular in cavities of the workpiece 102 to be treated.

In a phase of low pressure, the stable bubbles in the capillaries of the workpiece 102 expand, causing fluid to be expelled from the capillaries.

In a subsequent phase with higher pressure, the stable bubbles contract, drawing fluid into the capillaries.

Another part of the bubbles is not stable, but is in the form of transient cavitation bubbles. These transient cavitation bubbles implode when the pressure in the treatment chamber 104 is increased, which leads to very high flow velocities on the surface of the workpiece 102.

The microflows in the bath 106 of liquid treatment agent 112 cause a very effective exchange of the fluid on the surfaces of the workpiece 102, particularly on the surfaces of bores and/or capillaries of the workpiece 102.

A high concentration of oxygen on the surface of a workpiece 102 to be passivated favours the formation of oxides and thus the formation of a passivation layer.

In a particular embodiment of the treatment process as a passivation process, the oxygen concentration in the passivating agent within the treatment chamber 104 is therefore detected by at least one measuring sensor.

If the oxygen concentration in the passivating agent falls below a lower limit value, the oxygen concentration is raised by supplying air to the lower region of the treatment chamber 104. In order to enable such an air supply into the passivating agent, it can be provided that the treatment chamber 104 is provided with at least one pearl nozzle.

The limit value of the oxygen concentration below which oxygen is added to the passivating agent is preferably at least 5 mg/l and/or preferably at most 8 mg/l.

In order to promote the generation of microflows directly on the surface of a workpiece 102 to be treated in combination with the cyclical pressure changes and thus to obtain an even greater exchange of the fluids, it can be provided that the apparatus 100 is provided with at least one ultrasonic transducer 214, by means of which the bath 106 of liquid treatment agent 112 in the interior of the treatment chamber 104 and/or the workpiece 102 is subjectable to ultrasound.

The ultrasonic frequency is preferably at least 20 kHz, particularly preferably at least 25 kHz.

Furthermore, the ultrasonic frequency is preferably at most 120 kHz, particularly preferably at most 80 KHz.

The ultrasonic power coupled into the interior of the treatment chamber 104 by means of the ultrasonic transducer 214 or by means of a plurality of ultrasonic transducers 214 is preferably at least 5 watts per litre of liquid treatment agent 112 in the treatment chamber 104, particularly preferably at least 8 watts per litre of liquid treatment agent 112 in the treatment chamber 104.

Furthermore, the ultrasonic power coupled into the treatment chamber 104 is preferably at most 20 watts per litre of liquid treatment agent 112 in the treatment chamber 104, particularly preferably at most 15 watts per litre of liquid treatment agent 112 in the treatment chamber 104.

By modulating the amplitude of the ultrasonic oscillations and/or by modulating the ultrasonic frequency (so-called “sweep” function), the effect of acting on the bath 106 of liquid treatment agent 112 and/or the workpiece 102 can be further intensified and the effect of the exposure to ultrasound can be evenly distributed over all surfaces of the workpiece 102 to be treated.

When the desired number of pressure change cycles or the desired pressure change time has been reached, the workpiece 102 to be treated is removed from the bath 106 of liquid treatment agent 112 again, so that the at least one workpiece 102 to be treated is preferably arranged completely above the bath level 304 again.

Now a further pressure change operation is carried out while a treatment region of the workpiece 102 previously immersed in the bath 106 of liquid treatment agent 112 is removed from the bath 106 of liquid treatment agent 112.

This pressure change operation can be carried out in the same way as the pressure change operation described above with reference to FIG. 2. When the desired number of pressure change cycles or the desired pressure change time has been reached, the pressure change operation is ended.

If the desired total treatment time has not yet been reached, the treatment operation described so far is repeated by heating the at least one workpiece 102 by means of the heating device 300 at least in a surface region thereof.

The heated surface region of the workpiece 102 to be treated can be the same as in the previous heating process, or a different surface region of the workpiece 102 can be heated in the further heating operation.

After reaching the desired heating time or the desired heating temperature, the workpiece 102 to be treated is again immersed (by actuation of the fill level changing apparatus 306 and/or the workpiece moving apparatus by the control apparatus) completely or partially in the bath 106 of liquid treatment agent 112.

Subsequently, with the workpiece 102 at least partially immersed in the bath 106 of liquid treatment agent 112, a further pressure change operation is carried out with one or more pressure change cycles of the type described above.

After reaching the desired number of pressure change cycles or the desired pressure change time, the workpiece 102 to be treated is removed from the bath 106 of liquid treatment agent 112 again, so that the workpiece 102 is preferably arranged completely above the bath level 304.

Lastly, when the desired total treatment time has been reached, the pressure in the interior of the treatment chamber 104 is reduced in order to remove residues of the liquid treatment agent from capillaries of the at least one workpiece 102.

The pressure in the treatment chamber 104 is then increased to atmospheric pressure by opening the vent valve 298, and the at least one treated workpiece 102 is removed from the interior of the treatment chamber 104.

For many applications, the workpieces 102 treated, for example passivated, by means of the apparatus 100 must not have any residues of the liquid treatment agent 112, for example the passivating agent, on their surfaces for further processing. In particular, if a treated workpiece 102 has a cavity, a suitable process must be used to ensure that the liquid treatment agent 112 is sufficiently flushed out of such a cavity.

The treatment operation described above can therefore be followed by a rinsing operation.

Deionised water, for example, is used as the rinsing liquid.

To carry out the rinsing process, the treatment agent 112 is emptied into the storage container 122 by means of the open valve 150 and the emptying line 148.

Subsequently, the interior 106 of the treatment chamber 104 is at least partially filled with the rinsing liquid by means of a rinsing liquid supply (not shown in the drawings).

During the rinsing process, the pressure in the treatment chamber 104 can also be changed cyclically, as described above in conjunction with the treatment operation.

The cyclical pressure changes flush the rinsing liquid into the constrictions and capillaries of the treated workpiece 102, whereby the treatment agent 112 is flushed out at the same time.

The rinsing effect and thus the removal of the liquid treatment agent 112 from the surfaces of the workpiece 102 can be favoured by applying ultrasound to the bath of rinsing liquid and/or the workpiece 102 in the treatment chamber 104, for example by the ultrasonic transducer 214, in particular by generating microflows close to the surface.

An alternative embodiment of a method of treating a workpiece 102 can be carried out using the above-described apparatus 100 for treating workpieces 102, as follows:

A workpiece 102 to be treated is introduced into the interior of the treatment chamber 104.

The interior of the treatment chamber 104 is filled with liquid treatment agent from the storage container 122 until the workpiece 102 is at least partially immersed in the bath 106 of liquid treatment agent 112 (for example up to the bath level 304′ in FIG. 1).

A region of the workpiece 102 to be treated located above the bath level 304′ of the liquid treatment agent 112 is heated by means of radiant heat from the radiation source 302.

The pressure in the interior of the treatment chamber 104 is decreased (for example within an evacuation time of preferably at least one second and/or preferably at most three seconds) to the vapour pressure of the treatment agent.

The heated region of the workpiece 102 to be treated is immersed in the bath 106 of liquid treatment agent 112 by rotating the workpiece 102 about a horizontal axis of rotation through an angle of 180°.

Optionally, the workpiece 102 is left in the 180° rotated position during a holding time.

Due to the local heating of the liquid treatment agent 112 in the region adjacent to the now immersed heated region of the workpiece 102, the vapour pressure of the treatment agent is undershot there, resulting in bubble formation.

Subsequently, the pressure in the interior of the treatment chamber 104 is increased by a pressure difference, which is preferably at least 150 mbar and/or preferably at most 500 mbar, by air supply by means of the vent valve 298.

Optionally, the pressure in the interior of the treatment chamber 104 is left at the increased level during a holding time.

The region of the workpiece 102 removed from the bath 106 of liquid treatment agent 112 in this position is heated by means of radiant heat from the radiation source 302.

Subsequently, the pressure in the interior of the treatment chamber 104 is decreased again to the vapour pressure of the treatment agent during an evacuation time of preferably at least one second and/or preferably at most 3 seconds.

The workpiece 102 to be treated is again rotated through an angle of 180° about the horizontal axis of rotation, so that the region of the workpiece 102 heated during the second heating phase is now immersed in the bath 106 of liquid treatment agent 112.

Optionally, the workpiece 102 remains in this position—again rotated through 180°—during a holding time.

By locally increasing the temperature of the liquid treatment agent 112 in the region adjacent to the region of the workpiece 102 that has been heated in the second heating phase, bubble formation is generated.

The pressure in the interior of the treatment chamber 104 is again increased by a pressure difference, which is preferably at least 150 mbar and/or preferably at most 500 mbar, by supplying air by means of the vent valve 298.

The treatment operation described above can then be repeated one or more times.

After the intended total treatment time has elapsed, the interior of the treatment chamber 104 is venting to atmospheric pressure by means of the vent valve 298, and the treated workpiece 102 is removed from the interior of the treatment chamber 104.

During the entire treatment operation or at least during a part of the treatment operation, the workpiece 102 to be treated and/or the bath 106 of liquid treatment agent 112 can be subjected to ultrasound by means of one or more ultrasonic transducers 214.

1. A method for treating a workpiece, said method comprising the following:
introducing at least one workpiece into a treatment chamber;
providing a bath of a liquid treatment agent in the treatment chamber; and
cyclically changing a pressure in the treatment chamber while the liquid treatment agent is in the treatment chamber;
wherein the method further comprises the following:
carrying out at least one pressure change operation in the treatment chamber, during a course of which the pressure in the treatment chamber is decreased at least once and increased at least once while at least one treatment region of at least one workpiece is outside the bath of liquid treatment agent; and
carrying out at least one pressure change operation in the treatment chamber, during the course of which the pressure in the treatment chamber is decreased at least once and is increased at least once while the at least one treatment region of the at least one workpiece is within the bath of liquid treatment agent.

2. The method in accordance with claim 1, wherein the following applies:
a) the pressure change operation which is carried out while the at least one treatment region of the at least one workpiece is outside the bath of liquid treatment agent comprises i) a plurality of phases in which the pressure in the treatment chamber is decreased and/or ii) a plurality of phases in which the pressure in the treatment chamber is increased; and/or
b) the pressure change operation which is carried out while the at least one treatment region of the at least one workpiece is within the bath of liquid treatment agent, comprises i) a plurality of phases in which the pressure in the treatment chamber is decreased and/or ii) a plurality of phases in which the pressure in the treatment chamber is increased.

3. The method in accordance with claim 1, wherein a pressure change operation is carried out in the treatment chamber while a first treatment region of a first workpiece is outside the bath of liquid treatment agent and a second treatment region of the same workpiece or a treatment region of a second workpiece is within the bath of liquid treatment agent.

4. The method in accordance with claim 1, wherein the at least one treatment region of the at least one workpiece is immersed in the bath of liquid treatment agent or removed from the bath of liquid treatment agent by changing a filling height of the bath of liquid treatment agent in the treatment chamber.

5. The method in accordance with claim 4, wherein, in order to change the filling height of the bath of liquid treatment agent in the treatment chamber, the liquid treatment agent is drained from the treatment chamber or the liquid treatment agent is introduced into the treatment chamber by delivery by way of a pump or by delivery by way of a pressure gradient.

6. The method in accordance with claim 1, wherein a filling height of the bath of liquid treatment agent in the treatment chamber is maintained at a constant level by supplying the liquid treatment agent into the treatment chamber or by discharging the liquid treatment agent from the treatment chamber while the at least one workpiece is immersed in the bath of liquid treatment agent in the treatment chamber or the at least one workpiece is removed from the bath of liquid treatment agent in the treatment chamber.

7. The method in accordance with claim 1, wherein the at least one treatment region of the at least one workpiece is moved i) linearly and/or ii) rotationally relative to the treatment chamber in order to immerse the treatment region in the bath of liquid treatment agent or in order to remove the treatment region from the bath of liquid treatment agent.

8. The method in accordance with claim 1, wherein a relative movement of the at least one treatment region of the at least one workpiece relative to the bath of liquid treatment agent in the treatment chamber is synchronised with a pressure change operation in the treatment chamber.

9. The method in accordance with claim 1, wherein the following applies:
a) i) a movement of the at least one treatment region of the at least one workpiece relative to the bath of liquid treatment agent in the treatment chamber and/or ii) a position of the at least one treatment region of the at least one workpiece relative to the bath of liquid treatment agent in the treatment chamber is controlled in dependence on the pressure in the treatment chamber; and/or
b) the pressure in the treatment chamber is controlled in dependence on i) the movement of the at least one treatment region of the at least one workpiece relative to the bath of liquid treatment agent in the treatment chamber and/or ii) the position of the at least one treatment region of the at least one workpiece relative to the bath of liquid treatment agent in the treatment chamber.

10. The method in accordance with claim 1, wherein the at least one treatment region of the at least one workpiece is immersed in the bath of liquid treatment agent when the pressure in the treatment chamber is lower than a maximum pressure during a pressure change operation in the treatment chamber.

11. The method in accordance with claim 1, wherein the at least one treatment region of the at least one workpiece is removed from the bath of liquid treatment agent in the treatment chamber when the pressure in the treatment chamber is higher than a minimum pressure during a pressure change operation in the treatment chamber.

12. The method in accordance with claim 1, wherein i) the at least one workpiece and/or ii) the bath of liquid treatment agent in the treatment chamber is subjected to ultrasound while the pressure in the treatment chamber is changed or during an intermediate phase between two phases in which the pressure in the treatment chamber is changed.

13. The method in accordance with claim 1, wherein the pressure in the treatment chamber is increased to ambient pressure or above ambient pressure during a pressure change operation in the treatment chamber.

14. The method in accordance with claim 1, wherein the pressure in the treatment chamber is increased by feeding i) an inert gas and/or ii) a high-purity gas into the treatment chamber.

15. The method in accordance with claim 1, wherein the at least one treatment region of the at least one workpiece is moved relative to the treatment chamber during a pressure change operation in the treatment chamber.

16. The method in accordance with claim 1, wherein, during the at least one pressure change operation of the at least one workpiece in the treatment chamber, at least two pressure change operations are carried out which differ from one another with respect to at least one parameter, wherein the differing parameter is i) a minimum pressure during the pressure change operation, ii) a maximum pressure during the pressure change operation, iii) a period of time during which the pressure in the treatment chamber is decreased, and/or iv) a period of time during which the pressure in the treatment chamber is increased.

17. The method in accordance with claim 1, wherein the at least one pressure change operation comprises a plurality of cyclic pressure changes, in which the pressure in the treatment chamber is always above a boiling pressure of the liquid treatment agent in the treatment chamber, and a holding of the pressure in the treatment chamber at the boiling pressure or below the boiling pressure of the liquid treatment agent in the treatment chamber.

18. The method in accordance with claim 1, wherein at least one process parameter comprises i) a minimum pressure during a pressure change operation of the at least one pressure change operation, ii) a maximum pressure during the pressure change operation, iii) a period of time during which the pressure in the treatment chamber is decreased, iv) a period of time during which the pressure in the treatment chamber is increased, and/or v) a speed, by which the at least one treatment region of the at least one workpiece is moved relative to the bath of liquid treatment agent in the treatment chamber, is changed in dependence on measurement data from at least one sensor in dependence on i) a temperature, ii) a pressure, and/or iii) a conductance.

19. The method in accordance with claim 1, wherein the at least one treatment region of the at least one workpiece is heated i) during a pressure change operation of the at least one pressure change operation and/or ii) outside the pressure change operation.

20. The method in accordance with claim 19, wherein the at least one treatment region of the at least one workpiece is heated by exposing the workpiece to i) electromagnetic radiation, ii) a plasma, iii) hot air, iv) a superheated steam, v) a dry steam, and/or vi) a hot liquid medium comprising a hot cleaning medium.

21. The method in accordance with claim 20, wherein the at least one treatment region of the at least one workpiece is heated such that a temperature of the treatment region concerned is above a temperature of the liquid treatment agent in the bath of liquid treatment agent in the treatment chamber.

22. An apparatus for treating workpieces, comprising
a treatment chamber for receiving at least one workpiece and a bath of a liquid treatment agent;
a pressure changing apparatus for decreasing and increasing a pressure in the treatment chamber while treatment agent is in the treatment chamber; and
a device for at least partially immersing at least one treatment region of the at least one workpiece in the bath of liquid treatment agent.

23. The apparatus in accordance with claim 22, wherein the apparatus comprises a heating apparatus by way of which at least one treatment region of the at least one workpiece is heatable while the treatment region concerned of the at least one workpiece is outside the bath of liquid treatment agent in the treatment chamber.

24. The apparatus in accordance with claim 23, wherein the heating apparatus is configured such that at least one treatment region of the at least one workpiece is heatable by way of the heating apparatus by applying i) electromagnetic radiation, ii) a plasma, iii) hot air, iv) superheated steam, v) dry steam, and/or vi) a hot liquid medium comprising a cleaning medium, to the treatment region concerned of the workpiece.

25. The apparatus in accordance with claim 23, wherein at least a part of the heating apparatus is separable from a vapour space of the treatment chamber by way of a separating apparatus.

26. The apparatus in accordance with claim 22, wherein the apparatus comprises at least one sensor for i) detecting a position of the at least one workpiece, ii) detecting a movement of the at least one workpiece relative to the treatment chamber, and/or iii) detecting at least one parameter of the bath of liquid treatment agent.

27. The apparatus in accordance with claim 26, wherein the apparatus comprises a control apparatus by way of which the pressure changing apparatus is controllable in dependence on a signal of the at least one sensor for detecting i) the position of the at least one workpiece, ii) the movement of the at least one workpiece relative to the treatment chamber, and/or iii) the at least one parameter of the bath of liquid treatment agent.
